(19) United States
(12) Patent Application Publication
(10) Pub. No.: US 2004/0094729 A1
(43) Pub. Date: May 20, 2004

(54) Security marking method and items provided with security marks

(76) Inventors: Luc Struye, Mortsel (BE); Paul Leblans, Kontich (BE); Rudy van den Bergh, Lint (BE)

Correspondence Address: Joseph T. Guy Ph.D., Nexsen Pruet Jacobs & Pollard LLP, 201 W. McBee Avenue, Greenville, SC, 29603, US

(21) Appl. No.: 10/356,621

(22) Filed: Nov. 20, 2002

(51) Int. Cl. G01N 21/63

(52) U.S. Cl. 250/581

(57) ABSTRACT

An apparatus and a method in which the apparatus is used in order to provide ability to test and ascertain the authenticity an item differing from a radiation image storage phosphor panel, characterized in that said item is applied onto or into at least part thereof, with storage phosphor particles, wherein said method comprises the steps of checking for presence of a selected storage phosphor onto or into said item, by first irradiating the item with electromagnetic radiation having a wavelength shorter than the wavelength emitted by the stimulable phosphor, stimulating the phosphor with electromagnetic radiation having a wavelength longer than the wavelength emitted by the phosphor, detecting the stimulated emission of the phosphor and transforming the light signal into a visual and/or an audio signal.

### FIELD OF THE INVENTION

The present invention relates to an authentic item, a system or method and an apparatus suitable for use in that method providing ability to test the authenticity of said item, wherein said item differs from a radiation image storage phosphor screen and wherein said item has been marked with at least one stimulable phosphor in favor of ascertaining authenticity.

### BACKGROUND OF THE INVENTION

In order to protect authentic banknotes, paycards and official documents like passports, identity cards, against forgery, special features are added. One particular feature is the application of a layer containing a luminescent material that emits light upon excitation with UV-radiation. Materials containing such luminescent particles, either organic or inorganic, may emit light of several colors and the phosphor layer in which the luminescent articles are embedded, may be structured so that numbers or letters appear upon exposure of the protected document to UV-excitation.

The more particular the added feature is and the more difficult it is to manufacture the materials to which are added the features, the better its protection against forgery.

In recent years, use of luminescent materials for document protection has become widespread and many different kinds of luminescent materials are available that emit light when excited with ultra-violet radiazion. So quite a lot of materials exist that emit visible in the red green or blue region of the spectrum. The emission color of different luminescent materials can however often hardly be distinguished and luminescent materials, either organic or inorganic, are manufactured by many industries throughout the world.

Therefore, the search for more particular features that require less commonly known materials has intensively been subject to ongoing research, taking into account the remark that markings should have the property not to be permanent (as e.g. with irreversible changes from invisible to“visible”) as the well-informed forger, whose interest will have been pointed to these technical means for revealing such markings, will therefore be aware of the markings to be imitated.

### OBJECTS OF THE INVENTION

It is a first object of the present invention to provide items the authenticity of which can be proved in order to protect them against forgery.

It is another object of the present invention to provide a method to prove authenticity of said items, more particularly bank-notes, paycards and official documents like passports, identity cards, etc., in order to protect them against forgery in a more secure way than has ever been performed hitherto.

It has moreover been an object of the present invention to add more particular features, differing from the commonly known features used today in applications providing tracability of authenticity.

It is a further object of the invention to provide an apparatus suitable for use in the system or method of the present invention to unambiguously provide ability to test the authenticity of the items referred to hereinbefore.

Other objects will become apparent from the description and the claims hereinafter.

### SUMMARY OF THE INVENTION

The above mentioned objects have been realized by providing an item differing from a storage phosphor panel characterized in that said item is provided or marked onto or into at least part thereof, with storage phosphor particles having a specific composition.

A method of testing the authenticity of items in order to prove authenticity in order to protect them against forgery has further been claimed, said method comprising the steps of:

incorporating into or onto an item a (one or more type(s) of) specific stimulable (storage) phosphor(s);

checking for presence of the said storage phosphor(s) by first irradiating the authentic item with electromagnetic radiation having a wavelength shorter than the wavelength emitted by the specific stimulable phosphor(s) and

stimulating the phosphor(s) with electromagnetic radiation having a wavelength longer than the wavelength emitted by the said phosphor(s) and

(simultaneously) detecting the stimulated emission of the said specific phosphor(s) and transforming the light signal into a visual and/or an audio signal.

An apparatus providing ability to test the authenticity of items has further been claimed, wherein said apparatus comprises (in a housing):

a first source emitting electromagnetic radiation having a wavelength shorter than the emission wavelength of the specific storage phosphor(s),

a second source emitting electromagnetic radiation having a wavelength within the stimulation spectrum of the specific storage phosphor(s),

(optionally) an optical filter stopping light generated from the said second source and transmitting emission light generated by the specific storage phosphor(s),

a detector transforming the light signal transmitted by said optical filter into an electrical signal, an amplifier amplifying the electrical signal,

a signalling unit, indicating the presence or absence of storage phosphor(s) through a visual and/or audio signal.

The housing of said apparatus further comprises at least three compartments, divided by optical filters, placed in such a way that light only reaches another compartment by passing said filters.

Specific features for preferred embodiments of the invention are set out in the dependent claims.

Further advantages and embodiments of the present invention will become apparent from the following description and drawings.

### BRIEF DESCRIPTION OF THE DRAWINGS

FIG. 1 shows the relation between excitation, emission and stimulation spectra of a storage phosphor, also called stimulable phosphor.

FIG. 2 represents a sketch of an apparatus according to the present invention for use in order to demonstrate presence of a storage phosphor in an item, the authenticity of which should be proved, wherein at least following parts are required:

(1): housing;

(2): item under investigation;

(3): source emitting electromagnetic radiation having a wavelength shorter than the emission wavelength of the storage phosphor (excitation source);

(4): optical filter stopping the light of source (3) and transmitting the emission light of the storage phosphor;

(5): stimulating source emitting electromagnetic radiation having a wavelength within the stimulation spectrum of the storage phosphor;

(6): optical filter to attenuate the shorter wavelengths emitted by source (5)

(7): optical filter to attenuate the stimulating light

(8): light detector

(9): electronic part

(10): indicator (visually detecting—lamp—, audio singal releasing—beeper—, etc.)

As electronic items it is clear that detectors transforming light signals into an electrical signal; amplifiers amplifying the electrical signals and signalling or alarming units, indicating presence or absence of storage phosphor by means of a visual and/or an audio signal are required.

FIG. 2 is illustrative for a practical example as explained more in detail in the EXAMPLES of the present invention.

### DETAILED DESCRIPTION OF THE INVENTION

The above mentioned objects have been realized by incorporating into or onto the items to be protected against forgery and the authenticity of which has to be ascertained and detected, one or more so-called stimulable (storage) phosphors, wherein said item clearly differs from a radiation image storage phosphor screen or panel for medical diagnostic purposes, and wherein time to confirm the authenticity more than once without need for re-exposure with high energetic electromagnetic radiation having a wavelength shorter than the wavelength emitted by the stimulable phosphor is even provided.

According to the present invention an item differing from a storage phosphor panel is characterized in that said item is provided, onto or into at least part thereof, with storage phosphor particles of a selected stimulable phosphor. More in particular according to the present invention said item provided (at least in or on part thereof) with stimulable phosphors is selected from the group consisting of authentic banknotes, paycards, credit cards, identification badges, official documents (like passports or identity cards), and rare or precious articles.

Said selected stimulable phosphors are known as differing from the classically well-known luminescent phosphor materials in that upon exposure to electromagnetic radiation of such phosphors storage of energy appears, wherein said energy has a wavelength shorter than the wavelength of the light emitted by the phosphor. The light emitted is thus not spontaneously released like is the case for luminescent materials as e.g. in WO 81/03507, but the storage phosphor releases the stored energy in form of visible light upon optical stimulation, i.e., upon exposure to light having a wavelength longer than the emission wavelength of the phosphor having stored energy. Moreover its stored energy is not completely released at once as is the case for phosphorescent articles as described in U.S. Pat. No. 4,387,112 wherein stored energy is fairly integrally lost after stimulation with infrared radiation or stimulation with thermal or electrical fields.

According to the method of the present invention, repeated checking for presence of the said storage phosphor is made by further stimulating and detecting, without further irradiating the item. It is clear however that this application is limited as by stimulation part of the stored energy disappears. As a consequence the energy per square millimeter used during stimulation should be reduced in order to make more than one controll possible. Although such a method may lay burden upon the reliability thereof, due to the lower stimulation energy applied, certain advantages may however be expected. Moreover the rate at which the signal decreases with consecutive detection strongly depends upon the composition of the storage phosphor used. By calculating the stimulation energy using the data of the decrease of the signal, the type of phosphor used can be discovered. So CsBr:Eu, when used as stimulable phosphor, will show a rapidly decreasing signal, due to its lower stimulation energy than e.g. BaFBr:Eu which will less rapidly decrease as a consequence of its higher stimulation energy.

It is clear that it is not an object to protect or identify storage phosphor screens or panels known by anyone skilled in the art in digital radiographic imaging or in dosimetry, as disclosed in quite a lot of patents like U.S. Pat. Nos. 4,585,944; 4,491,736; 4,350,893; 4,511,208; 4,505,989; 4,926,047; 4,535,238; 4,782,237; 4,571,496; 4,574,102; 4,608,190; 4,616,135; 4,752,557; 4,769,549; 4,837,436; 5,055,681; 5,296,117; 5,632,930; 5,654,555; 5,886,354; 5,986,279; 6,045,722 and 6,271,528; in U.S. application Ser. No. 00 159 004 and in EP-A's 0 174 875, 0 185 534, 1 001 276, 1 001 277, 1 063 505, 1 150 303 and 1 158 540, without however being limited thereto.

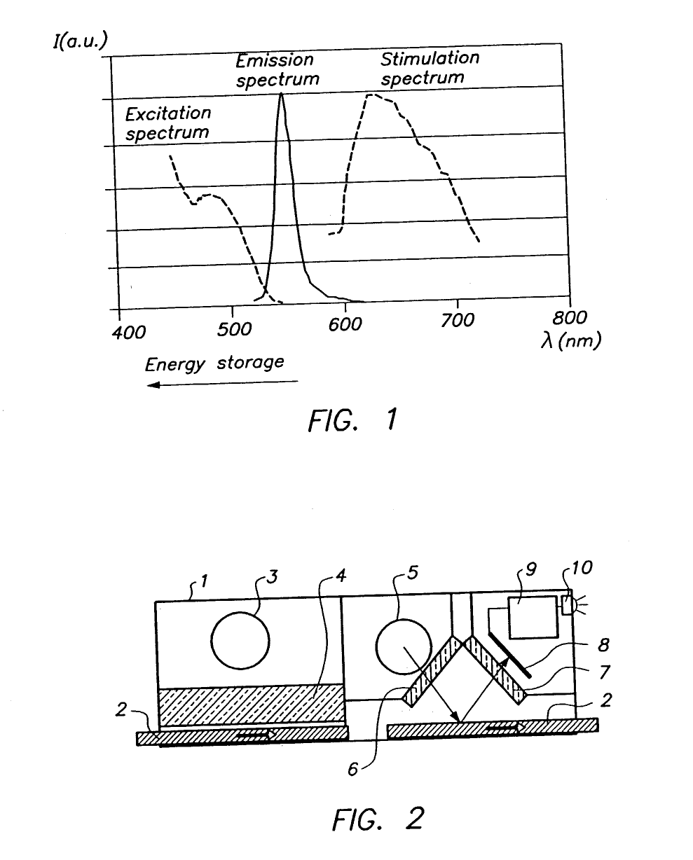

The relation between excitation, emission and stimulation spectra of a storage phosphors, particles of which are present in authentic items according to the present invention, has been shown in FIG. 1 as already set forth.

According to the present invention a method is further provided for testing the authenticity of items, wherein said method comprises the steps of (1) incorporating into such item a (layer) containing a specific stimulable (storage) phosphor; (2) checking for the presence of the storage phosphor by first irradiating the item with electromagnetic radiation having a wavelength shorter than the wavelength emitted by the said specific stimulable phosphor and stimulating the said phosphor with electromagnetic radiation having a wavelength longer than the wavelength emitted by the said phosphor and detecting the stimulated emission energy of the phosphor, thereby further transforming the light signal into a visual and/or an audio signal, wherein said phosphor is composed of

M^{II}FX:Eu⁺², M^{II} representing Ba or Sr and X representing Br or I, or

M^{I}X′:Eu²⁺, M^{I} representing an alkali metal and X′ representing Br or Cl.

Stimulable phosphors, particularly suitable for use as specifically selected storage phosphor particles in authentic items, protected by the method according to the present invention are:

M^{II}FX: Eu²⁺ (M^{II}=Ba, Sr; X=Br, I);

M^{I}X′:Eu²⁺ (M^{I}=alkalimetal, X′=Br, Cl),

M^{II}₅M^{IIII} O₄X″₆:Eu²⁺ (M^{II}=Ba, Sr; X″=Cl, Br, I),

M^{II}B₅O₉X″:EU²⁺ (M^{II}=Ba, Sr; X″=Cl, Br, I).

According to a preferred embodiment according to the method of the present invention said specific stimulable phosphor is composed of M^{II}FX:Eu²⁺, wherein M^{II} represents Ba or Sr and X represents Br or I. Most preferred from these phosphor compositions is BaFBr:Eu²⁺.

In another preferred embodiment according to the method of the present invention said stimulable phosphor is composed of M^{I}X′:Eu²⁺, M^{II} representing an alkali metal and X′ representing Br or Cl, such as e.g. CsX′:Eu²⁺. Most preferred therein is CsBr:Eu²⁺.

As a stimulable phosphor is characterized by its own specific excitation spectrum, specific emission spectrum and specific stimulation spectrum, every stimulable phosphor is unique. Two storage phosphors may e.g. have very similar emission spectra, but may have clearly different stimulation spectra. Those spectral differences make a discrimination between the two phosphors possible and therefore an unambiguous test of the authenticity of items available as will be explained hereinafter.

Presence of a storage phosphor in an item the authenticity of which has to be protected, can be demonstrated in two different preferred ways, thus improving the degree of protection:

its presence can be demonstrated in the usual way, i.e. by exciting direct light emission through exposure to ultra-violet-radiation: visual inspection of the color and the pattern of the light emission will indicate the presence of a luminescent compound in the protected item;

2) presence of the right type of storage phosphor can be demonstrated: therefore an apparatus according to the present invention is used wherein, in a first step, the phosphor is exposed to short wavelength radiation, whereby energy is stored in the storage phosphor; whereas in the second step, the phosphor is exposed to electromagnetic radiation having a wavelength within the stimulation spectrum of the storage phosphor, thereby causing stimulated light emission, which is detected by the apparatus.

As in 2) the detection is more selective an apparatus and system have been provided by the present invention in order to selectively examine the authenticity of particular items.

A particular and unique detection system is thus provided to prove authenticity and to secure such items from forgery or counterfeiting.

The apparatus according to the present invention providing ability to test the authenticity of corresponding items marked with one or more storage phosphors is comprised of:

a first source emitting electromagnetic radiation having a wavelength shorter than the emission wavelength of the storage phosphor,

a second source emitting electromagnetic radiation having a wavelength within the stimulation spectrum of the storage phosphor,

an optical filter stopping light generated from the said second source and transmitting emission light generated by the specific storage phosphor used,

a detector transforming the light signal transmitted by said optical filter into an electrical signal, an amplifier amplifying the electrical signal,

a signalling unit, indicating the presence or absence of storage phosphor through a visual and/or audio signal.

As set forth hereinbefore FIG. 2 represents a sketch of such an apparatus according to the present invention, providing ability to demonstrate the presence of one or more storage phosphor(s) in an authentic item of the present invention, marked with said phosphor(s). The authentic item under investigation carrying a storage phosphor (2) becomes illuminated or exposed to a radiation source (3) emitting electromagnetic radiation having a wavelength shorter than the emission wavelength of the storage phosphor, thus providing energy to be stored by the storage phosphor.

The energy thus stored after exposing the item (2), after transport to another compartment of the housing (1), becomes released by a source (5) emitting electromagnetic radiation, said source (5) having a wavelength within the stimulation spectrum of the storage phosphor present in the item (2). In the second part of the housing (1), an optical filter (6) stops the light of source (5) and transmits the stimulation light in order to stimulate emission of light from the storage phosphor present in item (2). A detector (8) transforms the light signal transmitted by the optical filter (7) into an electrical signal; and an electronic unit (9) amplifies the electrical signal: if present, thus proving presence of authentic storage phosphors in the item, the signalling and/or alarming unit (10), indicates the presence of the storage phosphor by means of a visual and/or an audio signal as expected. Absence of such a signal, which signal can be detected more than once after repeated stimulation in order to check and confirm authenticity of the item, clearly lays burden thereupon!

According to the present invention the apparatus comprises a first light source (see (3) in FIG. 2) having a wavelength shorter than the wavelength emitted by the stimulable phosphor after stimulation, wherein said first light source is an ultra-violet light source.

According to the present invention the apparatus comprises a second light source (see (5) in FIG. 2) having a wavelength capable to stimulate the storage phosphor with electromagnetic radiation having a wavelength longer than the wavelength emitted by the phosphor in the item, wherein said second light source is a diode laser.

Further according to the present invention the apparatus comprises an optical filter (7) stopping light of said second source and transmitting emission light of the storage phosphor from the item (2), wherein said filter is a BG3 filter or a BG39 filter.

In a preferred embodiment in the apparatus, according to the present invention, said light detector is a diode.

As the stimulable phosphors mentioned above are very sensitive, they allow to be coated or to be incorporated (in layers covering a whole surface or only part of it) up to a lower limit of 10 mg/cm² and even up to a lower limit of 1 mg/cm². Those low amounts are clearly in favor of cost and environmental load. Introducing into or onto only part of the item to be marked, a layer of phosphor pigments forming at least one layer coated with dispersed stimulable phosphor particles in order to mark the items, is highly recommended, in order to provide detection of authenticity.

Stimulable phosphor particles suitable for use in items as claimed in the present invention are preferably present in an outermost layer, wherein a localisation on top, protruding or included into said outermost layer depends, besides the dimensions of the item, on the way in which the stimulable phosphor particles have been applied. In dispersed form in a binder the stimulable phosphor particles can be coated in a polymeric layer acting as a protective outermost layer or they can be coated in layer, overcoated with an outermost (polymeric) layer, wherein both layers can be applied consecutively or simultaneously. Any coating or printing process may be used in order to provide the item according to the present invention with stimulable phosphor particles, in order to provide security measures in order to test the authenticity of the said items.

In another embodiment the storage phosphor particles are incorporated in an ink formulation providing ability to be printed on the item by any technique, as e.g. ink-jet technique.

In still another embodiment the storage phosphor particles are incorporated in a toner formulation providing ability to be printed by any technique relied thereupon.

The storage phosphor particles are, in another embodiment, present in basic materials or raw materials as, e.g., in raw materials used in order to prepare paper or plastic foils and the like. In this case the stimulable phosphor particles are incorporated into the paper or plastic foil itself (suitable for use e.g. as“packaging material” in particular cases).

As items are flexible to a minor or greater extent, it depends upon its specific properties how to apply the stimulable phosphor particles in the most suitable way, known in the art.

Moreover, and more particularly for rare or very unique items or items having been produced in an low number or restricted amount, the item can be marked in order to trace its manufacturing history in an easy way. So in one embodiment the stimulable phosphor is applied locally in a bar-code (by any method known in the art to apply a bar-code): when the said bar-code contains the manufacturing time (year, month, day, hour, minute, second) the item is fully characterized and place, as well as the manufacturing company and even the owner (in cases wherein items are“personalized”). In such applications a preferred storage phosphor is one of the particularly selected BaFBr:Eu or CsBr:Eu phosphors, in powder or in needle-shaped columnar, prismatic or honeycomb form.

In order to provide protection of authenticity characteristics by presence of the storage phosphor(s) as a marking tool, in that it that can withstand any attempt to remove said phosphors, e.g. by repeated rubbing or treatment with organic solvents in order to remove any sign of authenticity for whatever a reason, it is recommended to mix the phosphor in a formulation as set forth above (e.g. in an ink or toner formulation, or in a dispersion together with a binder, as e.g. in paper or plastic). Attempts to remove said phosphors will consequently require damage of part of the item at the surface (e.g. removing ink or toner). Therefore it may be advisable that the stimulable phosphor is not present at the surface of the item, but under a surface protective overcoat layer or dispersed in said layer. Inactivating the phosphor by irradiation (e.g. by ultra-violet irradiation) is excluded and any chemical treatment will leave an indication mark of improper use.

In order to protect the marking of an item by selected storage phosphors from damage as a consequence of variable stress (and deterioration of the physical strength) during manutention, more particularly for items showing a high (but not unlimited) degree of flexibility, it is recommended to make use of storage phosphors having a small particle size. Phosphor particles having larger sizes will clearly require measures in order to avoid too large forces on the phosphor particles when bending an item. Although particles having larger sizes are much more sensitive, it is recommended to make use of particles have a size, varying in the range from 4 μm up to 20 μm, from a viewpoint of mechanical (bending) properties and difficulty to remove them from an item.

Moreover embedding the phosphors in a flexible binder will reduce the influence of forces made thereupon. Therefore the most recommended method remains incorporation of the storage phosphor particles in raw materials such as e.g. paper or plastic, suitable for use as support material.

In a further preferred embodiment the protective layer on top of said support material, forming a first protective surface, is appliied as a radiation curable composition on (an area of) said surface and“radiation curing” said (area of) said surface may form further steps in the manufacturing.

In another embodiment image-wise removing said protective layer from an area of said first face, forming thereby an image with pits may be another embodiment. In still another embodiment application of a dyestuff or, in the alternative, even a second (or still further) dyestuff like e.g. the photochemically stable Cu-sulphonated phthalocyanine, may appear in said pits. Filling said pits with a colorless radiation curable composition and radiation curing said radiation curable composition may form further steps.

Image-wise removing a portion of said radiation cured area provides possibility of further marking the item under examination, e.g. with a particular numerical or alphabetic figure.

In another embodiment direct application of a specific indication (e.g. by ink-jet or toner-jet techniques) in form of a logo or a specific figure or digit, character, diagram or pattern, or trademark is possible, as well as application of said indications by any known printing technique, wherein (silk-)screen printing is one of the most preferred printing techniques (besides flexography or rotary screen printing).

Authenticity can unambiguously be detected by comparing the emission spectra of the stimulable phosphors with expected emission spectra. In a preferred embodiment however, the detection source is selected in such a way that it is sensitive in a narrow spectral region, wherein a video or audio signal can be expected once a “sensitivity treshold” has been exceeded. Apart from the spectrum of the emitted light, this“sensitivity treshold” is dependent on the particle size of the stimulable phosphor particles and of the amount of phosphor particles present per square cm. In view of the cost of such a sophisticated apparatus, which may be used for detection of authenticity of some very rare and extremely expensive items, an apparatus having in its simplest form the ability to make a distinction between blue, green and red light is sufficient with respect to an application within the scope of the present invention.

In a dynamic scanning system wherein a scanning proceeds with a laser as a light source the spot diameter may vary from 200 μm up to 1 mm. A spot diameter up to 5 cm may however be used when static detections are envisaged. It is clear however that, in order to stimulate the energy stored in the stimulable phoshor, the sensitivity is proportional with the surface area of the laser spot.

Static controll over the whole surface of the item consequently permits coverage of low amounts of stimulable phosphor over the whole surface. If smaller surfaces are covered and dynamic scanning is performed, it is clear that higher amounts of storage phosphor(s) will be required.

Parameters relevant to determine the best choice of a data storage system for a particular application are

ease of recording the information (i.e., what special equipment is needed, how much time does it take);

compactness of the recorded information and storage criteria, permanence and erasability, and

ease of reading.

In addition, a potentially desirable characteristic, especially for storage of information which has a designed, limited usage, is the controll of the time duration of the information storage. For example, if information is recorded in such a manner that it will effectively disappear after a predetermined period of time, use of a credit card, identification badge or other similar device could be automatically terminated by the expiration of the device by disappearance of the recorded information.

Further,“ease of reading” may either be a desired or an undesired characteristic. For example, it may be desirable that information only be accessible by means of a machine that is not generally available to the public. For instance, if the information stored should be maintained as a secret, the more difficult it is to access and the harder it will be for other parties to get the information.

“Ease of writing” has both negative and positive implications for the security industry. Ideally, recording and storage of information should be easy and economically justified for those who have access to the correct equipment, but difficult for anyone else. One of the reasons that credit card forgery is a major problem is that the information that is on the magnetic data storage strip that runs across the back of most credit cards is easy to access and moreover easy to change.

Several investigators have explored the use of optical memory crystals having light sensitive color centers as an information storage medium. Ionic crystals, such as alkali halides, have been specifically identified as suitable for use for these purposes.

According to the invention disclosed in U.S. Pat. No. 5,581,499 e.g. the lifetime of the recorded information making use of the formation of color centers can therefore be increased whenever needed by using insulating cadmium fluoride samples, preferentially doped with monovalent cations. Optimization of storage conditions in this case is accomplished either by increasing the duration of irradiation when it is necessary or by selecting higher primary current intensities with lower electron energies for given beam powers. When higher values of information density are required, the task consists in raising the electron energy and lowering the magnitude of the beam intensity for a given power and irradiation time. Although densities higher than 10⁷ bits/cm² are readily achievable, because of the nature of the different types of applications contemplated for that invention, much lower densities are suitable. Because an object of that invention is to store patterns which, at the final state of the retrieving process, produce visual images and because the lifetime of a stored pattern, and thereby of stored information, is an important element of the utility of the storage process, emphasis has been on providing storage devices and systems which allow a large variation of the ionising beam intensity. Electron microprobes are readily suitable for that purpose.

Once a suitable color center storage device is provided, a variety of commercially available devices can be used to retrieve the pattern stored based on color center phenomenon. Utilising the absorption by these centers of visible light, then, depending on the scale of the stored pattern, monochromatic or white light sources can be used along with magnifying systems ranging from simple magnifiers to visual (pocket microscopes) or projection microscopes to view the stored information when a magnification of several hundred times is required, readout in the transmitted mode is preferable and devices such as those used to retrieve microfilms can be used at a relatively low cost. When ultra-violet absorption is exploited, ultra-violet sources such as mercury vapour lamps can be used, the vapour pressure being such that either visible (high pressure) or ultra-violet (low pressure) emission is dominant depending on the application desired. For stored patterns having low reduction scale, commercially available bulbs of 3 watts power are suitable sources to achieve readout. Light with components in the near ultra-violet (300 nm or more) is suitable to read color center stored information. In this case, detection systems should be transparent in the ultra-violet region. For example, when quartz optics are used, fluorescent screens or electronic converters are necessary in order to transform the invisible radiation to a visible display.

The writing process using quenching of impurity (extrinsic) fluorescence is identical to that employed for the creation of the s color centers with the exception that electron beam powers and energies, and also the irradiation time, needed are much lower than for the latter process. Producing a large decrease in the efficiency of impurity fluorescence within small volumes constitutes the writing process. Each microscopic volume can be limited to the interaction volume of incident electrons, i.e., to that corresponding to the penetration depth of these electrons. As a result, one information bit has a size of the order of the electron size as long as the impurity concentration remains low.

Accordingly, the density of bits that can be stored within the IS crystal readily exceed 10⁸/cm² (depending on injected energy densities). Furthermore, to the extent that moderately low powers are used for reading, the information stored is not modified by light illumination as is the case for color centers.

Microscopic volumes having quenched impurity fluorescence constitute a set of information bits (data). These data are retrieved (read) by exciting these volumes by suitable radiation as for example, an electron beam generated in a scanning electron microscope. Great care must be taken because, excitation by even a weak energetic electron beam can irreversibly erase some of the stored information if the power density injected into the optical crystal is not suitably controlled. The preferred operation delivers the lowest beam power over the largest irradiated surface. If this is not the case, because of repeated electron bombardment from repetitive reading of the data, the lifetime of the stored information is shortened. The loss of contrast can be significant after only a limited number of reading cycles. While this may appear as a disadvantage of the technology, because of the invisible character of the stored information and its great sensitivity to incident ionising energy (i.e., to any retrieving operation which is not well controlled), this property is an advantage in a number of applications where a high degree of security is required as clandestine and improper accessing can protect the information by erasing or rendering unreadable the information.

As is clear from the description given hereinbefore, according to the present invention an item is envisaged to be ascertained or checked upon authenticity, wherein said item is differing from a storage phosphor panel and is provided onto or into at least part thereof with storage phosphor particles, composed of M^{II}FX:Eu²⁺, M^{II} representing Ba or Sr and X representing Br or I, or M^{I}X′:Eu²⁺, M^{I} representing an alkali metal and X′ representing Br or Cl; wherein said item is selected from the group consisting of authentic banknotes, paycards, credit cards, identification badges, official documents, and rare or precious articles.

While the present invention will hereinafter be described in connection with preferred embodiments thereof, it will be understood that it is not intended to limit the invention to those embodiments.

### EXAMPLE

A more detailed description of practical embodiments, schematically illustrated in FIG. 2, is disclosed in this example.

Therein following numbered parts (numbers between brackets) are shown for following arrangement of the apparatus.

The housing (1) was made of three compartments. The optical filters were placed in such a way that the light could only reach another compartment by passing the filters. Hereby the light from the excitation source (3) should only reach the card (2) under test and certainly not the detector. Also the light from the stimulation source that is not desired (outside the stimulation spectrum) as well as the non-desired light emitted from the storage phosphor present in the item (2) should be blocked by the combined arrangement of filter (6) and filter (7). Only the light emitted from the stimulable phosphor, detectable by the detector (8) must be able to reach the detector.

As an excitation lamp (3) a metal iodide lamp was used. Especially mercury- and thullium iodide lamps were preferred from the type HPI-T and HPI-BU from Philips-Lighting.

In the alternative spectral lamps could be used. The cadmium and the zinc lamp were preferred. As an alternative a combination from Cd and Hg or Tl could be used. Those lamps are provided on the market by several manufacturers, like Osram having the lamps Cd/10, Hg Cd/10, Tl/10 and Zn/10; UVP, Inc. Upland, Calif. USA 91786 having a Zinc Lamp (type 90-0069-050 and a Cadmium Lamp (Type 90-0071-03). Spectral lines used when working with the Cadmium Lamp were 326.1, 340.4, 346.6 and 361.1 nm. Spectral lines 467.8, 480 and 508.6 should be filtered away. Lines used with the Zinc Lamp were 307.6, 328.2, 330.3 and 334.6 nm. Lines 468, 472.2 and 481.1 should then be filtered away. The preferred optical filter (4) acting in order to attenuate the longer wavelengths of the excitation lamp (3) was a colored glass filter UG1 or UG11 (Company: Schott) having a thickness of 1 mm. Filter (4) is optional, in that in certain applications or circumstances the filter may be omitted. Laboratory tests have clearly shown that cadmium and zinc lamps from UVP may be used without filter.

As a stimulating light source (5) a green or red light emitting light source was used, and more particularly, a diode laser having a wavelength in the region 500 to 680 nm or, in the alternative a green or a red LED was used.

As an optical filter (6) to attenuate the shorter wavelengths of the stimulating source (5) colored glass filters GG475, GG495, OG515, OG530, OG550, OG570 and OG590 from the Schott Company were preferred. Those filters were suitable for attenuating the short wavelengths of the stimulating source that might pass through the optical filter (7) to attenuate the stimulating light. This filter absorbs the stimulating light and passes the light emitted from the fosfor: the colored glass filter BG3 or BG39 from the Schott Company were advantageously used. These filters might be provided with a dielectrical coating or a coating with a dye. Also a combination of BG3-3 mm and BG39-1 mm was well suitable.

As a light detector (8) any light detector sensitive in the blue region could be used, but as most sensitive the photomultiplier (any type of PMT from the Hamamatsu Company) could be used. Alternatively a photodiode, a CCD or an avalanche diode could be used successfully.

The electronic part (9) was containing a sensitive current amplifier or IV-convertor that was amplifying the small electrical current from the detector. With a comparator and a sample & Hold circuit the indicating lamp was put“on” when a predefined level was exceeded. Once this predefined level was exceeded the signal was held until it was reset by the user. The electronics could eventually be connected with a PC in order to registrate the data.

As indicator (10) any indicator could be used, such as a lamp (a LED, a tungsten lamp), a display, a beeper, etc.

Having described in detail preferred embodiments of the current invention, it will now be apparent to those skilled in the art that numerous modifications can be made therein without departing from the scope of the invention as defined in the appending claims.

What is claimed is:

1. A method for proving authenticity of an item differing from a storage phosphor screen, wherein said item is provided onto or into at least part thereof, with storage phosphor particles, said method comprising the steps of:
checking for presence of the said storage (stimulable) phosphor by first irradiating the item with electromagnetic radiation having a wavelength shorter than the wavelength emitted by the stimulable phosphor,
stimulating the phosphor with electromagnetic radiation having a wavelength longer than the wavelength emitted by the phosphor,
detecting the stimulated emission of the phosphor and transforming the light signal into a visual and/or an audio signal,
wherein said stimulable phosphor is composed of M^{II}FX:Eu²⁺, M^{II} representing Ba or Sr and X representing Br or I.

2. A method for proving authenticity of an item differing from a storage phosphor screen, wherein said item is provided onto or into at least part thereof, with storage phosphor particles, said method comprising the steps of:
checking for presence of the said storage (stimulable) phosphor by first irradiating the item with electromagnetic radiation having a wavelength shorter than the wavelength emitted by the stimulable phosphor,
stimulating the phosphor with electromagnetic radiation having a wavelength longer than the wavelength emitted by the phosphor,
detecting the stimulated emission of the phosphor and transforming the light signal into a visual and/or an audio signal,
wherein said stimulable phosphor is composed of M^{I}X′:Eu²⁺, M^{I} representing an alkali metal and X′ representing Br or Cl.

3. Method according to claim 1, wherein said phosphor is BaFBr:Eu²⁺.

4. Method according to claim 2, wherein said phosphor is CsBr:Eu²⁺.

5. Method according to claim 1, wherein repeated checking for presence of the said storage phosphor is made by further stimulating and detecting, without further irradiating the item.

6. Method according to claim 2, wherein repeated checking for presence of the said storage phosphor is made by further stimulating and detecting, without further irradiating the item.

7. An apparatus comprising in a housing:
a first source emitting electromagnetic radiation having a wavelength shorter than the emission wavelength of a storage phosphor,
a second source emitting electromagnetic radiation having a wavelength within the stimulation spectrum of a storage phosphor,
an optical filter stopping light generated from said second source and transmitting emission light generated by a storage phosphor,
a detector transforming the light signal transmitted by said optical filter into an electrical signal, an amplifier amplifying the electrical signal and
a signalling unit, indicating presence or absence of storage phosphors through a visual and/or audio signal,
wherein said phosphor is composed of M^{II}FX:Eu²⁺, M^{II} representing Ba or Sr and X representing Br or I.

8. An apparatus comprising in a housing:
a first source emitting electromagnetic radiation having a wavelength shorter than the emission wavelength of a storage phosphor,
a second source emitting electromagnetic radiation having a wavelength within the stimulation spectrum of a storage phosphor,
an optical filter stopping light generated from said second source and transmitting emission light generated by a storage phosphor,
a detector transforming the light signal transmitted by said optical filter into an electrical signal, an amplifier amplifying the electrical signal and
a signalling unit, indicating presence or absence of storage phosphors through a visual and/or audio signal,
wherein said phosphor is composed of M^{I}X′:Eu²⁺, M^{I} representing an alkali metal and X′ representing Br or Cl.

9. Apparatus according to claim 7, wherein said housing comprises at least three compartments, divided by optical filters, placed in such a way that light only reaches another compartment by passing said filters.

10. Apparatus according to claim 8, wherein said housing comprises at least three compartments, divided by optical filters, placed in such a way that light only reaches another compartment by passing said filters.

11. Apparatus according to claim 7, wherein the first light source having a wavelength shorter than the wavelength emitted by the stimulable phosphor after stimulation, is an ultra-violet light source.

12. Apparatus according to claim 8, wherein the first light source having a wavelength shorter than the wavelength emitted by the stimulable phosphor after stimulation, is an ultra-violet light source.

13. Apparatus according to claim 7, wherein the second light source having a wavelength capable to stimulate the storage phosphor with electromagnetic radiation having a wavelength longer than the wavelength emitted by the phosphor, is a diode laser.

14. Apparatus according to claim 8, wherein the second light source having a wavelength capable to stimulate the storage phosphor with electromagnetic radiation having a wavelength longer than the wavelength emitted by the phosphor, is a diode laser.

15. Apparatus according to claim 7, wherein the optical filter stopping light of said second source and transmitting emission light of the storage phosphor is a BG3 filter or a BG39 filter.

16. Apparatus according to claim 8, wherein the optical filter stopping light of said second source and transmitting emission light of the storage phosphor is a BG3 filter or a BG39 filter.

17. Apparatus according to claim 7, wherein said light detector is a diode.

18. Apparatus according to claim 8, wherein said light detector is a diode.

19. Item differing from a storage phosphor panel provided onto or into at least part thereof with storage phosphor particles, composed of M^{II}FX:Eu²⁺, M^{II} representing Ba or Sr and X representing Br or I, wherein said item is selected from the group consisting of authentic banknotes, paycards, credit cards, identification badges, official documents, and rare or precious articles.

20. Item differing from a storage phosphor panel provided onto or into at least part thereof with storage phosphor particles, composed of M^{I}X′:Eu²⁺, M^{I} representing an alkali metal and X′ representing Br or Cl, wherein said item is selected from the group consisting of authentic banknotes, paycards, credit cards, identification badges, official documents, and rare or precious articles.
